(19) United States
(12) Patent Application Publication
(10) Pub. No.: US 2006/0153627 A1
(43) Pub. Date: Jul. 13, 2006

(54) Automobile window washer apparatus

(76) Inventor: William V. Mathis, Little Rock, AR (US)

Correspondence Address: J. Charles Dougherty;Wright, Lindsey & Jennings LLP, 200 West Capitol Avenue, Suite 2300, Little Rock, AR, 72201-3699, US

(21) Appl. No.: 11/033,714

(22) Filed: Jan. 12, 2005

(51) Int. Cl. A47L 13/12; B43K 5/00

(52) U.S. Cl. 401/263; 401/261

(57) ABSTRACT

A self-contained device that allows persons to easily clean the windows of their vehicles is disclosed. The device features a housing to which a cleaning wand is retractably tethered. The cleaning wand operates in a manner similar to a squeegee, but is fed cleaning fluid through the hose connected to the wand from a reservoir within the housing. Fluid is dispensed adjacent to a wiping blade on the cleaning wand, thereby allowing a person to easily wash a vehicle window without the mess normally associated with the use of a squeegee. The device may be coin-operated, thereby distributing fluid only when a coin is inserted by the person and for a set period of time.

### BACKGROUND OF THE INVENTION

The present invention relates to window cleaning systems, and in particular to self-contained window cleaning systems for automobiles.

In former times, automobile service stations typically provided a full range of services to their customers, including the service of washing the customer's windshield at no additional charge. With the popularity of self-service stations today, no attendant is likely to be found to perform this service at most service stations. It is, however, a common practice for service stations to provide their self-service customers with a means by which to clean the windshield and other windows of their vehicles. The most common device for this purpose, often referred to as a “squeegee,” consists of a bar-shaped cleaning head with an elongated handle. On one side of the cleaning head is a flexible rubber strip. The opposite side of the cleaning head is fitted with a sponge, typically encased in a nylon netting material for durability. The sponge is generally used to draw cleaning fluid to the surface of the window from a reservoir where the squeegee is kept, while the rubber strip is used for the actual cleaning of the window surface. The squeegee devices are often kept available to the customer at the service station “island” where fuel dispensing pumps are also located. The reservoirs provided that contain glass cleaning fluid are generally open on top, and the cleaning head of the device is dunked in this reservoir for storage between uses.

One of the chief problems with squeegee-type window cleaning devices is that they are often lost or stolen by service station customers. As a result, service station owners must replace these devices on a frequent basis, increasing the service station's costs of operation. Since service stations do not have a workable means of charging for the use of the devices, they cannot recoup any of these losses. On the other hand, failure to replace squeegee devices when lost or stolen may anger customers who expect to be able to clean their windows while refueling their vehicles, and thereby lead to a loss of business for the service station.

Another problem with these devices is that the open reservoir used to contain washing fluid often becomes polluted. Since the squeegee is returned to the cleaning fluid reservoir after each use, dirt, grease, and other such materials on the squeegee cleaning surfaces are deposited back into the cleaning fluid. reservoir. In addition, since the cleaning fluid reservoir is open to the air, customers may at times discard cigarette butts and other refuse into the reservoir. As a result of these problems, the cleaning fluid must be replaced regularly, and thus much of the cleaning fluid placed into the reservoir is ultimately wasted. The size of the reservoir is generally kept small so as to lessen this problem, thereby limiting the amount of fluid that is lost when the reservoir is polluted. The small reservoir size means, however, that the reservoirs must be checked and refilled often. This leads to increased labor cost for service station owners.

Yet another problem with these devices is that they are difficult for customers to use without dripping fluid upon their clothing or skin. The squeegee will be dripping fluid from its sponge cleaning head upon removal from the open reservoir. As the cleaning head is raised to the level of the vehicle window, the customer must move the device slowly and carefully to avoid splashing the fluid. Since customers are often rushed when stopping to refuel their vehicles at a service station, it is common for customers to soil their clothing or skin with the cleaning fluid during this operation.

What is desired then is an apparatus that allows a customer to quickly and conveniently wash his or her window while refueling his vehicle at a service station, which reduces the cost of operation for the service station owner. Ideally, such an apparatus would actually allow the service station owner to generate additional income from the use of the apparatus by customers.

### BRIEF SUMMARY OF THE INVENTION

The present invention is directed to an apparatus that allows service station customers to clean the windows of their vehicles while generating income for the service station owner. The device features a housing to which a cleaning wand is tethered. The cleaning wand operates in a manner similar to a squeegee, but is fed cleaning fluid through a hose connected to the wand. Fluid is dispensed adjacent to the squeegee blade, thereby allowing the customer to easily wash a vehicle window without the mess normally associated with the use of a squeegee. The cleaning fluid tank is located within the housing to protect it from fouling. The device may be coin-operated, thereby distributing fluid only when a coin or other indicia of monetary value is inserted by the customer. The device may also feature a paper towel dispenser and lighted advertising to further increase revenues generated by the device.

It may be seen that such a device, while useful at a service station island, would be useful and desired in many other circumstances. For example, such a device may be placed adjacent to automated car washes for customers who do not have sufficient time for a complete car wash but desire their windows to be cleaned. It may also be seen that while such a device could be owned and operated by the owner of the property where it is located, it could also be maintained and operated by a third party, in the manner by which most vending machines are owned and operated today.

It is therefore an object of the present invention to provide for an automobile window washing apparatus that allows for the generation of revenue from customers who wish to wash their vehicle windows.

It is a further object of the present invention to provide for an automobile window washing apparatus that reduces the incidence of lost or damaged windshield washing equipment.

It is also an object of the present invention to provide for an automobile window washing apparatus that reduces the loss or waste of windshield washer fluid in connection with businesses that offer windshield washing equipment for their customers.

It is also an object of the present invention to provide for an automobile window washing apparatus that allows a vehicle owner to quickly and easily clean his or her vehicle windows.

These and other features, objects and advantages of the present invention will become better understood from a consideration of the following detailed description of the preferred embodiments and appended claims in conjunction with the drawings as described following.

### BRIEF DESCRIPTION OF THE SEVERAL VIEWS OF THE DRAWINGS

FIG. 1 is a cut-away perspective view of a preferred embodiment of the present invention.

FIG. 2 is a perspective view of a preferred embodiment of the present invention.

FIG. 3 is a front detail elevational view of a wand and cleaning head according to a preferred embodiment of the present invention.

FIG. 4 is a side detail elevational view of a wand and cleaning head according to a preferred embodiment of the present invention.

### DETAILED DESCRIPTION OF THE INVENTION

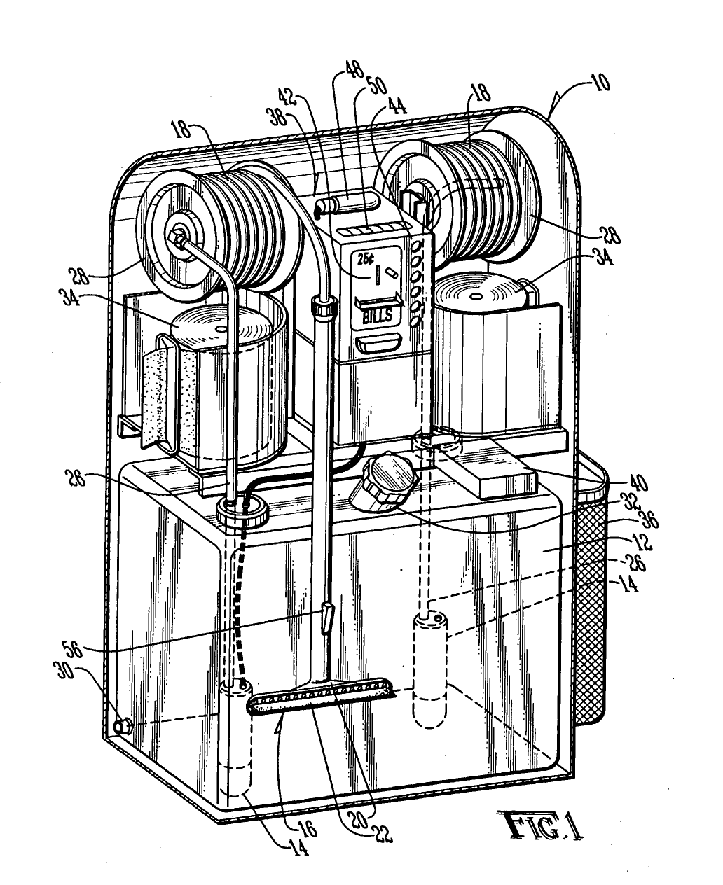

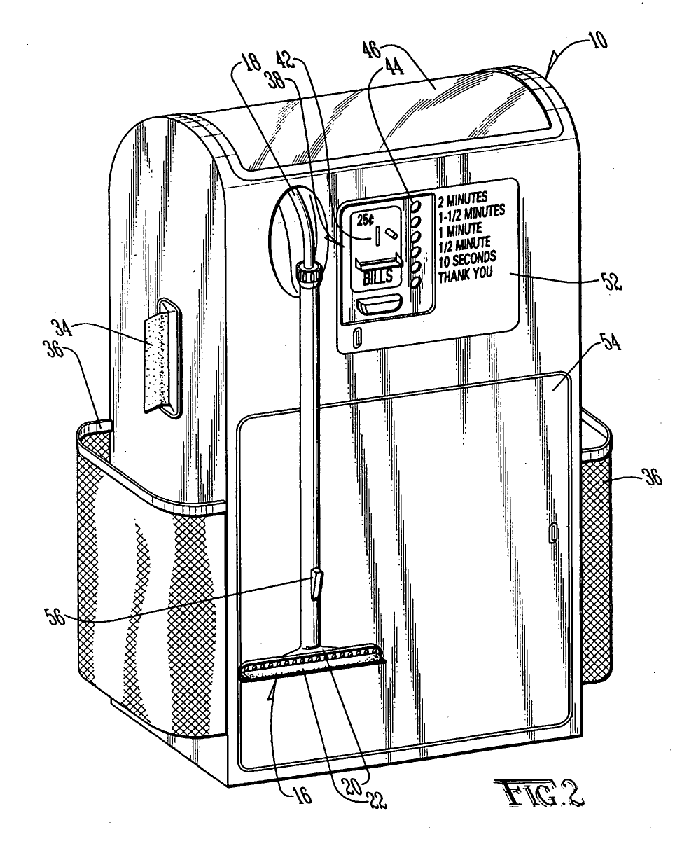

With reference to FIGS. 1 and 2, the preferred embodiment of the present invention may now be described. The preferred embodiment is a self-contained unit intended for installation at a service station island, self-service carwash, or other like areas where persons may bring their automobiles for other sorts of services. The preferred embodiment may, however, be installed in any location that would be accessible to an automobile.

Housing 10 forms the principal exterior component of the preferred embodiment. In preferred form, it is shaped roughly as an elongated box, with a rounded upper end similar in style to a common United States Postal Service public mailbox. For ease of access and in order to house all of the preferred components, the dimensions of a device according to the preferred embodiment of the present invention are about sixty inches tall, about eighteen inches deep, and about thirty inches wide. Various other sizes are possible in alternative embodiments. Housing 10 is preferably constructed of steel for strength, durability, and low manufacturing cost, but many other suitable materials may be substituted.

Fitted at either side of housing 10 of the preferred embodiment are cleaning wands 16. Cleaning wands 16 are attached to hoses 18 at one end of wands 16, and hoses 18 are coiled about spools 28 mounted within housing 10. Spools 28 are mounted in such a manner that they may freely rotate about an axis (not shown for clarity) within housing 10. Spools 28 are preferably spring-loaded in such a manner that they will automatically coil hoses 18 back onto spools 28 when a gentle tug is made at wand 16 or the attached hose 18. Hoses 18 are connected to spools 28 such that fluid may be delivered from an inlet at the side of spools 28 into hoses 18 and thus into a hollow longitudinal interior of wands 16.

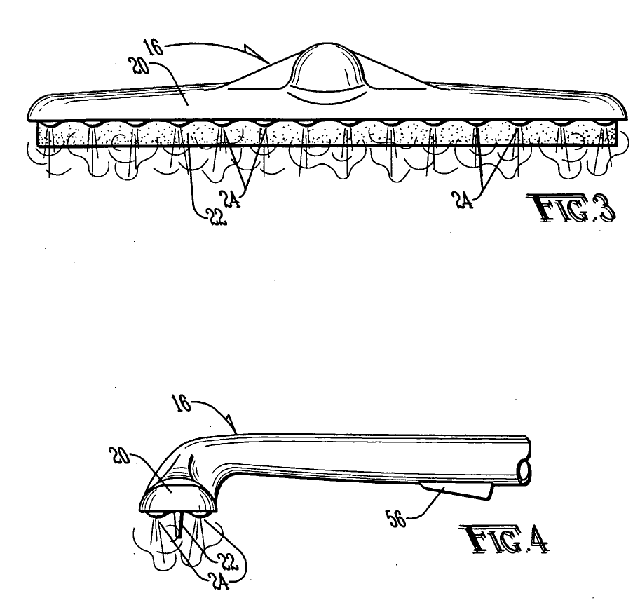

At the opposite end of wand 16 from its connection point with hose 18 is cleaning head 20, positioned perpendicularly to wand 16. The preferred embodiment of cleaning head 20 is shown in general in FIGS. 1 and 2, and in detail in FIGS. 3 and 4. Blade 22 is mounted longitudinally along cleaning head 20, thereby being positioned transverse to wand 16. Blade 22 is preferably formed of rubber or some other resilient material suitable for the cleaning of glass surfaces without damaging such surface.

On either side of blade 22 according to the preferred embodiment of the present invention is a row of nozzles 24. Nozzles 24 serve to dispense cleaning fluid from cleaning head 20 onto the glass surface to be cleaned. Preferably, nozzles 24 dispense cleaning fluid in an atomized mist, thereby provided an even coating of cleaning fluid to the glass surface to be cleaned. In alternative embodiments, any number of nozzles 24 may be employed, and such nozzles may alternatively appear on only one side of blade 22.

Trigger 56 is preferably disposed at a location along the length of wand 16 such that a user may easily depress trigger 56 while holding wand 16. Trigger 56 operates a valve internal to wand 16 (not shown) that functions to control the flow of fluid to nozzles 24. When trigger 56 is depressed, fluid is allowed to flow to nozzles 24, and otherwise the flow of fluid to nozzles 24 is blocked. In this way the user may easily control the flow of fluid through nozzles 24 while wand 16 is deployed in connection with the cleaning of vehicle windows.

It may be noted that in the preferred embodiment, two cleaning wands 16 are provided. This configuration is preferred where the device is mounted on a service station island or like location where a vehicle may pull alongside the device on either side. Thus two customers could wash their windshields and other vehicle glass surfaces simultaneously using the preferred embodiment. In other embodiments, a different number of wands 16 may be employed. For example, in an alternative embodiment intended for mounting on, against, or near a wall, only one cleaning wand 16 may be provided. In another alternative embodiment, four wands 16 may be provided, allowing two simultaneous users at either side of the device. This configuration may be desirable when placing the device between two double-sided gasoline pumps positioned along a service station island. While the description below concerning the preferred embodiment will assume a device using two wands 16, one positioned at either side of the device, it will be understood that all of the elements associated with the number of simultaneous users may be changed in number in a manner corresponding to the number of wands 16 employed with the device.

Fitted within the lower part of housing 10 of the preferred embodiment is fluid reservoir 12. The purpose of fluid reservoir 12 is to hold cleaning fluid that will be forced under pressure into cleaning head 20 and thus out through nozzles 22. In the preferred embodiment, reservoir 12 is sized to fill roughly the lower half of housing 10, thereby optimizing the amount of cleaning fluid that may be retained within the preferred embodiment, and thus reducing the required frequency of refilling. In the preferred embodiment as illustrated and with housing 10 dimensions as cited above, a reservoir 12 with a capacity of about 56.1 gallons, or 7.5 cubic feet, is preferred. Drain valve 30 is fitted to the lower portion of reservoir 12, extending through housing 10, to allow fluid to be drained from reservoir 12 when desired. In addition, collapsible fill spout 32 may be included in the preferred embodiment to provide a convenient means of filling reservoir 12 with cleaning fluid. In the preferred embodiment, reservoir door 54 is fitted to the front, back, or both front and back of housing 10 in order to facilitate access to reservoir 12, pumps 14, and adjacent components for maintenance or other purposes. Reservoir door 54 is preferably fitted with a locking mechanism to discourage theft or vandalism.

Positioned within reservoir 12 in the preferred embodiment are two low-velocity fluid pumps 14. These pumps are used to draw cleaning fluid from reservoir 12 up to cleaning head 20. In the preferred embodiment, pumps 14 may be implemented as any of a number of commercially available models, included those supplied by Johnson Controls, Inc. of Milwaukee, Wis. Feed lines 16 connect each pump 14 to a corresponding spool 28 such that cleaning fluid may be delivered from reservoir 12 to hose 18 through spool 28.

The preferred embodiment also includes the capability to distribute paper towels through paper towel rolls 34. Paper towel rolls 34 are mounted vertically in the preferred embodiment, in such a manner that paper towel rolls 34 may easily rotate, and the end of paper towel rolls 34 extends through a slot in either side of housing 10. Preferably, a serrated edge (not shown) is included along such slot in housing 10 whereby the customer may easily tear paper from a paper towel roll 34. Alternative embodiments may omit paper towel rolls 34, although they are included in the preferred embodiment since many persons cleaning their vehicle windows using a squeegee prefer to complete the window cleaning operation by wiping the window with a towel. Optional waste bins 36 may also be added to either side of housing 10; these waste bins are designed to receive spent paper towels distributed from paper towel rolls 34, but could be included as a general convenience to the customer even if paper towel rolls 34 are not included in a particular embodiment.

Operation of the device according to a preferred embodiment is controlled through controller subassembly 38. Power to controller subassembly 38 may be supplied by a separate power supply 40 through a wired connection (not shown) as illustrated in FIG. 1, or power supply 40 may be integrated with controller subassembly 40. In either case, power supply 40 receives electrical power through a standard plug (not shown) and converts it to the proper voltage and other physical parameters required for operation of controller subassembly 40. Controller subassembly 38 may optionally include usage meter 50 so that the operator of the device may more easily keep track of usage, but in the preferred embodiment the display portion of usage meter 50 is not visible to customers.

Controller subassembly 38 operates to switch on the appropriate pump 14, and thereby provide cleaning fluid through the corresponding cleaning head 20, in response to the deposit of an appropriate sum of money through monetary value input 42. In the preferred embodiment, each monetary value input 42 is designed to receive either coins or currency, and comprises a means of sorting and collecting coins and currency, and returning any change to the customer as appropriate based on the cost of the service. In alternative embodiments, monetary value input 42 could be designed to receive any other form of monetary value, including credit cards, debit cards, stored value cards, and the like. Such devices are commercially available from suppliers including Carlton-Bates Company of Little Rock, Ark. A monetary value input service door 52 may be included as a part of housing 10 in order to allow the operator of the device to easily access the coin and currency collection box of monetary value input 42, or to facilitate repairs. Monetary value input service door 52 preferably is fitted with a locking mechanism to discourage theft or vandalism.

Controller assembly 38 operates to determine when the appropriate amount of monetary value is received at monetary value input 42, and activates the corresponding pump 14 to provide cleaning flood to the corresponding cleaning head 20 for a set period of time based upon the monetary value input. Display 44 provides information to the customer concerning the amount of time remaining for use of the device. In the preferred embodiment, display 44 is a series of lights, with adjacent markings that indicate the time remaining for use of the device based upon the monetary value input. Alternatively, display 44 could be a digital countdown timer. In still other embodiments, display 44 could simply be an audible warning when a set amount of time remains, or display 44 could be eliminated altogether.

The preferred embodiment also includes advertising window 46 at the top of housing 10. Preferably, advertising window 46 is designed to receive replaceable advertisements printed onto transparent plastic sheets that may be fitted at window 46. Lamp 48, driven by controller subassembly 38, provides backlighting such that the message appearing in advertising window 46 is easily visible to customers at all times. Although the preferred usage of window 46 is advertising, it could be used for the communication of any other type of information, such as instructions or safety warnings concerning the use of the device. In alternative embodiments, window 46 and lamp 48 may be eliminated.

Operation of the preferred embodiment of the present invention begins by the customer pulling his or her vehicle adjacent to either side of housing 10. The customer then inserts the proper monetary value, whether coins or currency, into monetary value input 42. Change is returned if appropriate. In response to the receipt of the appropriate monetary amount, controller assembly 38 operates to activate the pump 14 corresponding to the wand 16 adjacent to the appropriate monetary value input 42. The customer may then clean the windows of his or her vehicle using wand 16, while cleaning fluid is dispensed through nozzles 24 on cleaning head 20 whenever the user depresses trigger 56. Display 44 keeps the customer apprised of the amount of time remaining during the use of wand 16. Once time expires, the customer may continue to use blade 22 of cleaning head 20 to wipe away excess cleaning fluid from his or her windows, as desired. Cleaning fluid, however, will no longer be available when trigger 56 is depressed. Once the cleaning operation is completed, the user may then lightly tug on wand 16, thereby activating the return mechanism of the appropriate spool 28 such that hose 18 is retracted into housing 10. The customer may then leave wand 16 hanging from housing 10 as shown in FIGS. 1 and 2. If desired, the customer may perform a final cleaning of his or her windows using paper towels from a paper towel roll 34, depositing any waste material in one of waste bins 36.

Maintenance and upkeep for the preferred embodiment of the device is similar to any other vending-type machine. The operator must periodically check the level of fluid in reservoir 12, and refill reservoir 12 as needed, preferably by means of fill spout 32. Coins and currency may be removed from monetary value input 42 periodically through the use of service door 52. Reservoir door 54 provides convenient access to reservoir 12 as well as other components of the device located internally within housing 10.

The present invention has been described with reference to certain preferred and alternative embodiments that are intended to be exemplary only and not limiting to the full scope of the present invention as set forth in the appended claims.

What is claimed is:

1. A window cleaning apparatus, comprising:
(a) a housing;
(b) a cleaning fluid reservoir within said housing;
(c) a wand comprising a cleaning head; and
(d) a hose operable to deliver cleaning fluid from said cleaning fluid reservoir to said cleaning head.

2. The window cleaning apparatus of claim 1, wherein said hose is retractable within said housing.

3. The window cleaning apparatus of claim 2, further comprising a reel within said housing, wherein said hose is disposed on said reel to be retractable within said housing, and wherein said reel is releasably biased to rotate such that said hose automatically retracts within said housing by being taken up on said reel.

4. The window cleaning apparatus of claim 2, further comprising a pump in communication with said hose and said cleaning fluid reservoir wherein said pump moves cleaning fluid from said cleaning fluid reservoir into said hose.

5. The window cleaning apparatus of claim 4, further comprising a controller operable to activate and deactivate said pump.

6. The window cleaning apparatus of claim 5, further comprising a usage meter in communication with said switch.

7. The window cleaning apparatus of claim 5, further comprising a monetary value input in communication with said controller.

8. The window cleaning apparatus of claim 7, wherein said monetary value input comprises a coin receiving, sorting, and counting apparatus.

9. The window cleaning apparatus of claim 5, further comprising a paper towel roll holder disposed within said housing such that a paper towel may be withdrawn from outside said housing.

10. The window cleaning apparatus of claim 5, further comprising a trigger mounted at said wand wherein said trigger is operable to control the flow of fluid through said wand.

11. The window cleaning apparatus of claim 5, wherein said cleaning head comprises a resilient blade and a cleaning fluid nozzle.

12. The window cleaning apparatus of claim 11, wherein said cleaning head further comprises a plurality of cleaning fluid nozzles, at least one of said cleaning fluid nozzles on each side of said cleaning head blade.

13. A window cleaning apparatus, comprising:
(a) a housing;
(b) a cleaning fluid reservoir within said housing;
(c) a first wand and second wand, each said wand comprising a cleaning head, and said first wand disposed on an opposite side of said housing from said second wand; and
(d) a first hose and second hose, each hose operable to deliver cleaning fluid from said cleaning fluid reservoir to one of said cleaning heads.

14. The window cleaning apparatus of claim 13, further comprising a plurality of reels within said housing, wherein each said hose is disposed on one of said reels to be retractable within said housing, and wherein each said reel is releasably biased to rotate such that said hose disposed on said reel automatically retracts within said housing by being taken up on said reel.

15. The window cleaning apparatus of claim 14, further comprising a first and second pump, each said pump being in communication with one said hose and said cleaning fluid reservoir wherein each said pump moves cleaning fluid from said cleaning fluid reservoir into the associated one of said hoses.

16. The window cleaning apparatus of claim 15, further comprising a controller in communication with said pumps operable to turn said pumps on and off.

17. The window cleaning apparatus of claim 16, further comprising a monetary value input in communication with said controller.

18. The window cleaning apparatus of claim 13, wherein each said cleaning head comprises a resilient blade and a cleaning fluid nozzle.

19. The window cleaning apparatus of claim 18, wherein each said cleaning head further comprises a plurality of cleaning fluid nozzles, at least one of said cleaning fluid nozzles on each side of each of said cleaning head blades.

20. The window cleaning apparatus of claim 19, comprising a plurality of cleaning fluid nozzles on each side of each of said cleaning head blades.
